(19) United States
(12) Patent Application Publication
(10) Pub. No.: US 2007/0160723 A1
(43) Pub. Date: Jul. 12, 2007

(54) Potato chips and other processed potato shapes with chocolate coating

(76) Inventors: Alfred Gerhold Rockefeller, Ramsey, NJ (US); A. Zeki Erdin, Franklin Lakes, NJ (US)

Correspondence Address: ALFRED G. ROCKEFELLER, 30 COBBLESTONE LANE, RAMSEY, NJ, 07446-2657, US

(21) Appl. No.: 11/649,968

(22) Filed: Jan. 5, 2007

Related U.S. Application Data
(60) Provisional application No. 60/757,312, filed on Jan. 9, 2006.

(51) Int. Cl. A23G 3/20

(52) U.S. Cl. 426/306; 426/302; 426/637

(57) ABSTRACT

This application discloses the concept of coating various baked or fried potato shapes with various types of chocolate including dark chocolate, milk chocolate, white chocolate and white chocolate mixed with food coloring. Also disclosed is the production methods (batch processing and continuous production) which may be altered minimally for conversion from producing fried and baked potato products to producing the same products coated with chocolate.

### CROSS REFERENCE TO RELATED APPLICATIONS

### United States Patent Application 20060068062

### CHOCOLATE CONFECTIONARY PRODUCTS AND METHODS OF PREPARING THE SAME

### National Filing Date Sep. 20, 2005

This application defines the concept of a confection composed of layers including a base coat of chocolate, an intermediate layer of a flavored food substance and an outer coating of chocolate covering a substrate of pretzels, potato chips and other food materials.

### U.S. Pat. No. 5,500,234

### CRISPY CHIP SANDWICH AND PROCESS OF PRODUCING A SANDWICH PRODUCT

### Issue Date Mar. 19, 1996

The above patent describes a multilayer cookie or snack using a crispy type food product as outer layers with two layers of marshmallow and one or more edible filler substances within.

### U.S. Pat. No. 5,731,020

### DISCRETE WAFER ASSEMBLED COOKIE AND METHOD OF MAKING SAME

### Issue Date Mar. 24, 1998

The above patent describes the ingredients and means of assembling a multi-layer cookie using potato chips or corn chips layered with edible food products, one of which may be chocolate. The cookie is to be assembled by the consumer.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

There have been products marketed which are composed of potato chips with a coating of chocolate applied to one side of each chip. The concept of chocolate coating various potato shapes in their entirety has not been observed in either the market place or in any literature the inventors are aware of.

### BRIEF SUMMARY OF THE INVENTION

This application defines the materials and methods necessary for the production of various fried or baked potato shapes coated with dark chocolate, milk chocolate, plain white chocolate or white chocolate mixed with a food coloring.

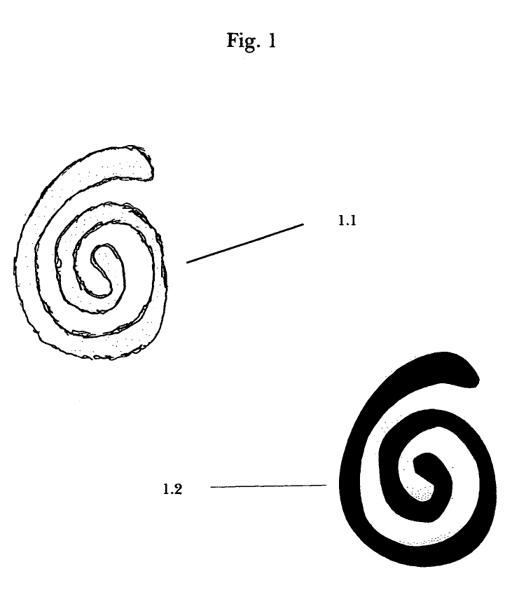

### BRIEF DESCRIPTION OF THE SEVERAL VIEWS OF THE DRAWINGS FIG. 1

FIG. 1 depicts a spiral cut potato shape.
1.1 shows a spiral cut potato shape as initially processed.
1.2 shows a spiral cut potato shape after coating with chocolate.

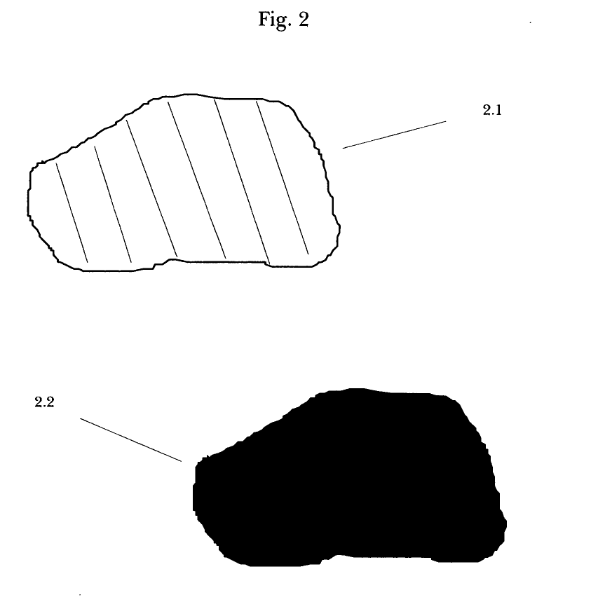

FIG. 2 depicts a potato chip.
2.1 shows a potato chip after initial processing
2.2 shows a potato chip after coating with chocolate.

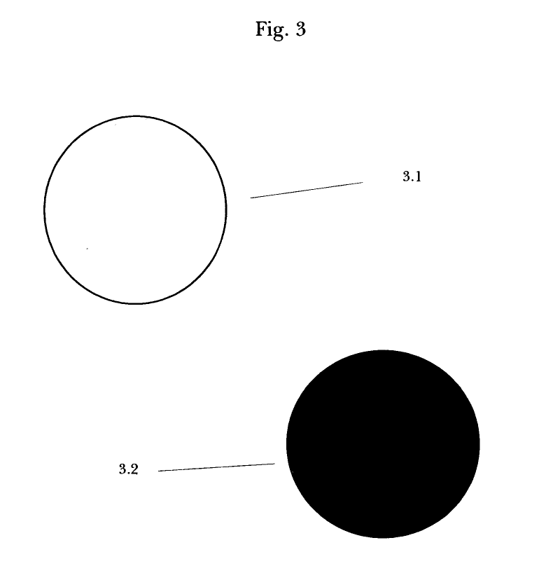

FIG. 3 depicts a round potato ball.
3.1 shows a round potato ball after initial processing.
3.2 shows a round potato ball after coating with chocolate.

### DETAILED DESCRIPTION OF THE INVENTION

This invention deals with methods of producing various potato shapes coated with chocolate.

These shapes include, but are not limited to, potato chips, potato sticks, round balls and spiral cut potatoes.

These shapes may be fabricated and processed as follows:

Potato chips, sticks or spiral shapes may be cut from whole potatoes and fried in the traditional way by means of either batch processing or, in the case of large scale production, may be processed in a continuous production facility. Alternatively, potatoes may be processed to produce a potato flour which is mixed with a binder, formed into various shapes and oven baked. This method may be used for potato chips, round potato balls and other three dimensional shapes and lends itself to large scale production. These methods are currently in use by various manufacturers.

Production machinery exists for both batch and large scale production. We will address each method in turn.

We envision a batch production facility to be in a small retail food outlet which sells in small quantities and produces small batches of product as needed.

This facility may employ existing potato processing machinery including hand activated potato cutters for producing potato shapes (such as chips, pomme frits and spiral cut) and deep fryers for producing finished product.

The retail outlet may offer various sauces for coating the product by the consumer. In addition, the merchant will have a series of pots containing heated chocolate of various types in which he will dip the finished potato shapes after which he will drain and cool the product prior to sale.

Large scale production will employ existing production lines for either fried or baked potato shapes. At the output of production where the product is usually packaged, the product instead will be routed to a production line usually used in candy manufacture. This second production line will coat the product with various types of chocolate by coating (for chips) or spraying (for three dimensional shapes. The line will then drain and cool the product and route to the packaging area. Packaging may have to be modified to ensure maintenance of product integrity in the retail environment.

1. This invention introduces the concept of coating various fried or baked potato shapes with various flavors of chocolate.
1.a Shapes will include potato chips, pomme frits, round balls and spiral cut.
1.b Chocolate flavors include dark chocolate, milk chocolate, white chocolate and white chocolate mixed with food colors.

2. Production may be done as a batch process or in a continuous production facility
2.a Both processes presently exist as production facilities for potato products. Minor modifications are necessary in either process for production of chocolate coated potato shapes.

3. Types of chocolate employed may include dark chocolate, milk chocolate, white chocolate and white chocolate mixed with food coloring.
